(19) United States
(12) Patent Application Publication
(10) Pub. No.: US 2014/0273268 A1
(43) Pub. Date: Sep. 18, 2014

(54) PREPARATION OF SAMPLES FOR ANALYSIS

(71) Applicant: EPREP PTY LTD, Ringwood, Victoria (AU)

(72) Inventors: Reno Cerra, Mooroolbark (AU); Peter Alexander Dawes, Warrandyte (AU)

(73) Assignee: EPREP PTY LTD., Ringwood, VIC (AU)

(21) Appl. No.: 14/350,537

(22) PCT Filed: Oct. 12, 2012
(86) PCT No.: PCT/AU2012/001291

§ 371 Date: Apr. 8, 2014

(30) Foreign Application Priority Data
Oct. 12, 2011 (AU) 2011904175

(51) Int. Cl. G01N 1/28

(52) U.S. Cl. CPC G01N 1/28
USPC 436/180; 422/509

(57) ABSTRACT

An apparatus for preparation of samples for analysis comprising includes structure (21) for interchangeably locating first racks of sample receptacles that contain samples to be prepared for analysis and second racks include racks of different configuration racks for of sample receptacles which second that are respectively transferable to different analysis instruments, and for receiving and positioning a plurality of reagent vessels at known respective positions. An assembly of devices (50,60) is actuable to transfer samples from sample receptacles of the first rack to sample receptacles of the second rack, while carrying out a sample preparation operation selected from a plurality of pre-programmed sample preparation operations, wherein the apparatus is configured to identify which of said the second racks of different configuration is located at said the structure, and to adapt said the transfer and said the selected sample preparation operation to suit the identified rack. In other respects, there is disclosed apparatus having a tool support (25) for tools that include positive displacement liquid handling tools, and a tool engagement and drive device (50) that is actuable to effect extraction and delivery by displacing the needles to sealingly penetrate, and thereafter withdraw from, closures on the first and second sample receptacles and reagent vessels.

### FIELD OF THE INVENTION

This invention relates generally to the preparation of samples for analysis and is concerned in particular with the efficient preparation of multiple samples for analysis, e.g. in high throughput analytic laboratories. In particular aspects, the invention is directed to an apparatus for preparation of samples for analysis, and to a method of preparing samples for analysis.

### BACKGROUND OF THE INVENTION

The managers of modern high volume analytical laboratories are able to equip their premises with a range of analytical instruments capable of rapidly handling a large number of sample analyses. Many of these instruments come equipped with auto-analyser platforms that can be loaded with racks of sample vials and deliver the vials in rapid succession for completion of the analytic task. These improvements in sample analysis have brought benefits in reduced labour costs and other operational efficiencies but surveys by the present applicant have found that these benefits have not been matched by corresponding productivity improvements in the preparation of samples for analyser instruments, so that sample preparation now typically accounts for a much higher proportion of laboratory costs, in the region of 45%, than each of sample collection, analysis and data interpretation.

Sample preparation is labour intensive, and complete sample preparation procedures rarely include just one process: collected data suggests that an average of three sample preparation processes are required per sample analysis. Moreover, sample preparation techniques are quite varied in nature and degree of complexity, and to perform multiple sample preparation procedures a typical laboratory would require several discrete devices, for example an autodiluter, an automated solid phase extraction system, filtration manifolds and so on. A further issue is that each sample preparation step is of different duration and the continued general reliance on human resources to complete these tasks consequently mitigates against improvements in workflow efficiency. Even though there is some automation available for the individual preparation tasks, the handling and transfer of sample vials between tasks is still largely a manual operation.

To the extent that efforts have been made to improve laboratory productivity, the emphasis has been at the analysis end of the workflow. Thus, for example, improvements have been provided via the auto-analyser racks mentioned earlier: these have tended to be analyser specific, rather than generic. A sample preparation instrument recently released onto the market utilises standard 2 ml vials arranged in proprietary racks that can be delivered to proprietary analyser instruments of the same supplier. The sample vials are processed through the instrument by performing certain preparation operations on the samples in the vials. In many cases, earlier labour-intensive preparation is still required, e.g. to transfer samples to the standard vials.

Another class of known sample preparation instruments employs translatable multi-pippette heads. For example, U.S. Pat. No. 5,139,744 describe's an “automated multipurpose analytical chemistry processing centre and laboratory workstation” having a multiunit pippettor and a translatable head that picks up the set of pippette tips, uses them to move samples from the sample containers of one rack to those of another, and then discards the tips. There are also “tools” or modules that include module 52: this module has a plunger controlled by a stepper motor, and a nozzle to which pippette tips are attached. The modules also include an optical device and pH measurement module. A variety of programmable protocols are disclosed.

US patent application 2004/0005714 discloses sample handling apparatus with multiunit vacuum operated pippettor heads. There is a deck with multiple stations, and sample container trays that are mountable at a respective specific station: the match is provided by a visual icon for manual systems or by a barcode or physical key for automated systems. With some trays, there is a further level of characterisation for reagent positions within each tray. That is, reagent receptacles must be mounted at specific positions on the trays identified by a second set of visual icons. The purpose of these arrangements is to prevent analytical errors through cross-contamination or reagent error.

US patent application 2008/0060719 by Massaro describes a robotic device for handling analytic tools such as multi-unit pippettor heads in a fashion such that the tools are operable both when carried by the robot and when placed on a support. The idea is to optimize efficiency of operation by having the robot at work with one tool head while other tool heads are carrying out their operation in situ.

A disclosure of a further workflow system for test sample and reagent transfer is to be found in U.S. Pat. No. 5,355,304.

The sample vials themselves are one source of another known difficulty for analytical laboratories, i.e. environmental contamination arising from the use of sample containers that are open during all or part of the sample preparation process. While it might seem obvious to simply use sealed containers, this is not so straightforward in terms of maintaining the seal while carrying out the operations of sample preparation: at least temporary removal of the closure is generally required. Standard pippettor based instruments cannot be used to directly aspirate liquid from, or dispense liquid into, sealed vials.

It is an object of the invention to provide a potential for productivity improvements in the sample preparation operations of an analytical laboratory.

It is a further object of the invention, at least in one or more aspects and/or embodiments, to address the problem of environmental contamination of samples during laboratory analysis.

Reference to any prior art in the specification is not, and should not be taken as, an acknowledgment or any form of suggestion that this prior art forms part of the common general knowledge in Australia or any other jurisdiction or that this prior art could reasonably be expected to be ascertained, understood and regarded as relevant by a person skilled in the art.

### SUMMARY OF THE INVENTION

The invention provides an apparatus actuable to carry out selectable sample preparation operations utilising racks of sample receptacles, sample handling devices or tools and plural reagent vessels. In different aspects, the invention entails the concepts of (1) interchangeable sample racks transferrable to different analysis instruments, i,e, off-line sample preparation rather than tethered or instrument specific sample preparation, (2) flexibility in relation to input vial type and/or size so that earlier preparation steps can be reduced, even eliminated and (3) interchangeable toots for transferring samples from input receptacles to different output receptacles while carrying out associated preparation steps, and (4) a drive head and tool combination that facilitates the use of needle-penetratable closures.

In a first aspect, the invention provides apparatus for preparation of samples for analysis, comprising:
structure for interchangeably locating first racks of sample receptacles that contain samples to be prepared for analysis and second racks of sample receptacles, which second racks include racks of different configuration that are respectively transferrable to different analysis instruments, and for receiving and positioning a plurality of reagent vessels at known respective positions; and
an assembly of devices actuable to transfer samples from sample receptacles of the first rack to sample receptacles of the second rack, while carrying out a sample preparation operation selected from a plurality of pre-programmed sample preparation operations;
wherein the apparatus is configured to identify which of said second racks of different configuration is located at said structure, and to adapt said transfer and said selected sample preparation operation to suit the identified rack.

In this manner, the apparatus is arranged to mount a range of proprietary racks utilised by proprietary analysis instruments of different types and different suppliers.

The structure may include a support base and interchangeable mounting mats to complement the second racks of different configurations. Such racks may, e.g., be of varying dimensions and/or vial location configurations. Identification of which of the second racks is located at the structure may be by means for identifying the presence of one of the mounting mats and for identifying the particular mat and thereby the complementary rack.

Preferably, the assembly of devices includes a tool support for receiving and positioning a plurality of sample handling tools at known respective positions, and a tool engagement and drive device carried by a mechanism for translating the device in three dimensional space, wherein the device and mechanism are actuable to carry out a sample preparation operation selected from a plurality of pre-programmed sample preparation operations, which selected operation includes picking up one or more of said tools, extracting sample liquid from one or more of said sample receptacles at the first racks and reagent from one or more of said reagent vessels, and delivering the prepared sample to one or more respective said sample receptacles at the second rack. Preferably, the sample handling tools include positive displacement liquid handling tools, e.g. syringes, having needles able to sealingly penetrate, and thereafter withdraw from, closures on sample receptacles and reagent vessels, for accessing and aspirating controlled volumes of sample or reagent, or for delivering the contents of the syringe to a sample receptacle.

The invention provides, in a second aspect, apparatus for preparation of samples for analysis, comprising:
structure for interchangeably locating racks of first sample receptacles that contain samples to be prepared for analysis and racks of second sample receptacles that are transferrable to analysis instruments, and for receiving and positioning a plurality of reagent vessels at known respective positions;
a tool support for receiving and positioning a plurality of sample handling tools at known respective positions which sample handling tools include positive displacement liquid handling tools, e.g. syringes, having needles able to sealingly penetrate closures on sample receptacles and reagent vessels; and
a tool engagement and drive device carried by a mechanism for translating the device in three dimensional space, wherein the device and mechanism are actuable to carry out a sample preparation operation selected from a plurality of pre-programmed sample preparation operations, which selected operation includes picking up one or more of said tools, extracting sample liquid from one or more of said first sample receptacles and optionally reagent from one or more of said reagent vessels, and delivering the prepared sample to one or more respective said second sample receptacles, and
wherein the tool engagement and drive device is actuable to effect said extraction and delivery by displacing the needles to sealingly penetrate and thereafter withdraw from closures on the first and second sample receptacles and reagent vessels.

In the second aspect, the invention is further directed to a method of preparing samples for analysis comprising:
delivering a rack of first sample receptacles that contain samples to be prepared for analysis;
locating racks of second sample receptacles that are transferrable to analysis instruments;
providing a plurality of reagent vessels at known respective positions;
providing at a tool support a plurality of sample handling tools at known respective positions which sample handling tools include positive displacement liquid handling tools, e.g. syringes, having needles able to sealingly penetrate closures on sample receptacles and reagent vessels; and
actuating a tool engagement and drive device and a mechanism for translating the device in three dimensional space to carry out a sequence of sample preparation operations selected from a plurality of pre-programmed sample preparation operations, which selected operations each include picking up one or more of said tools, extracting sample liquid from one or more of said first sample receptacles and reagent from one or more of said reagent vessels, and delivering the prepared sample to one ore more respective said second sample receptacles;
wherein the tool engagement and drive device effects said extraction and delivery by displacing the needles to sealingly penetrate and thereafter withdraw from closures on the first and second sample receptacles and reagent vessels.

In a convenient arrangement, said instrument includes a support base accessible from the front for interchanging racks and/or reagent vessels located on the structure. Conveniently, the reagent vessels are disposed between the first sample receptacles and the second sample receptacles.

With this arrangement, the tool support may comprise a plurality of tool mounts arranged along the rear of and above the support base, and the translation mechanism with its tool engagement and drive device are arranged so that the latter moves about and above the base for accessing sample receptacles, reagent vessels, and sample handling tools at the tool support.

Preferably, said structure further includes a support base and interchangeable mounting mats configured to complement respective racks of varying dimensions and/or vial location configurations. Means is preferably provided for identifying the presence of one of these rack mounting mats, and for identifying the particular mat and thereby the rack.

Advantageously, the tool engagement and drive device includes a head for releasably and selectively engaging the sample handling tools. A suitable such head is disclosed in applicant's International patent publication WO 2009/046482, the contents of which are incorporated herein by reference. The sample handling tools may include, for example, reusable syringes of varying volumes, single use syringes of varying volumes, a gripper, a stirrer, a vial spinner and a filtration syringe.

Preferably, in the first or second aspects of the invention, for when the first racks include racks of different configuration, the apparatus is configured to identify which of said first racks of different configuration is located at said structure, and to adapt said transfer and said selected sample preparation operation to suit the identified rack, whereby said apparatus is adaptable to process samples presented in first racks of varied configuration, that may include sample receptacles of varied types and/or sizes.

In a third aspect, the invention provides apparatus for preparation of samples for analysis, comprising:
structure for interchangeably locating first racks of sample receptacles that contain samples to be prepared for analysis and second racks of sample receptacles, which first racks include racks of different configuration, and for receiving and positioning a plurality of reagent vessels at known respective positions; and
an assembly of devices actuable to transfer samples from sample receptacles of the first rack to sample receptacles of the second rack, while carrying out a sample preparation operation selected from a plurality of pre-programmed sample preparation operations;
wherein the apparatus is configured to identify which of said first racks of different configuration is located at said structure, and to adapt said transfer and said selected sample preparation operation to suit the identified rack, whereby said apparatus is adaptable to process samples presented in first racks of varied configuration, that may include sample receptacles of varied types and/or sizes.

By virtue of the third aspect of the invention, the apparatus is adapted to locate input racks of receptacles or vials in which the samples were deposited at the point of collection, thus eliminating intervening sample preparation steps such as transferring or partitioning the samples to standard or dedicated vials for further handling.

The apparatus in any of the aspects of the invention preferably includes a control unit with an operator interface. The operator interface is conveniently a touch-screen for inputting selected sample preparation operations or tasks, typically from a set of pre-programmed sample preparation operations or tasks. The control unit is advantageously configured to display on said operator interface a graphical user interface comprising a matrix of user actuable control elements arranged in columns and rows, either the columns or rows being respectively for:
(1) displaying the identity of a rack of first sample receptacles located at said structure,
(2) displaying the identity of a rack of second sample receptacles located at said structure,
(3) selecting a reagent vessel from said plurality of reagent vessels,
(4) selecting a tool from said plurality of sample handling tools positioned at the tool support, and
(5) selecting a sample preparation task from a plurality of pre-programmed sample preparation tasks that are performed on sample liquid extracted from one or more of the first sample receptacles, utilise one or more of the sample handling tools, and deliver the prepared sample to a said second sample receptacle.

The method of the second aspect of the invention may further include providing on an operator interface a graphical user interface comprising a matrix of user actuable control elements arranged in columns and rows, either the columns or rows being respectively for performing the above said functions (1) to (5).

Preferably, the user actuable control elements for the above stated display or selection functions (1) to (5) are arranged as columns left to right, with rows then representing a sequence of combinations of the column elements.

As used herein, except where the context requires otherwise, the term “comprise” and variations of the term, such as “comprising”, “comprises” and “comprised”, are not intended to exclude further additives, components, integers or steps.

### BRIEF DESCRIPTION OF THE FIGURES

The invention will be further described, by way of example only, with reference to the accompanying drawings, in which:

FIG. 1 is an isometric view of apparatus according to an embodiment of the invention;

FIG. 2 is a front elevation of the apparatus; and

FIG. 3 is a snapshot of a graphical user interface depicting a set of displays or control elements or buttons for plural tasks constituting a sample preparation operation.

### DESCRIPTION OF EMBODIMENTS OF THE INVENTION

The illustrated sample preparation apparatus 10 includes a structural frame 11 having rear corner posts 12, 13 mounted by brackets 19 atop and towards the rear of elongate forwardly projecting side frame members 14, 15. These side frame members 14, 15 are joined at their front ends by a front rail 16 and further back by intermediate and rear rails 17, 18. The posts 12 are linked by a rear top rail 20 that sits on and slightly overhangs the tops of the posts, and approximately at their mid-points by a tool hanging rail 22 fitted to the front faces of the posts by brackets 23. A wall panel 150 is fitted to the rear faces of posts 12, 13 and rail 20.

Rails 16, 17 provide a support base 21 for a range of complementary rectangular mats 121-126 that support sample racks and reagent vessels. In this embodiment, the mats define, from left to right when viewed from the front of the apparatus, a first station 30 for interchangeably locating racks 32 of first sample receptacles that contain samples to be prepared for analysis, a reagent station 35 for receiving and positioning a plurality of reagent vessels 36 at known respective positions, and a second station 40 for interchangeably locating racks (not shown) of second sample receptacles that are transferrable to analysis instruments. The particular racks 32 illustrated in FIGS. 1 and 2 are standard Belart™ vial racks: four discrete empty racks are shown on respective pads 121-124. There is a single mat 125 with seats 125a for six reagent vessels 36, but this may be interchanged for other mats with different numbers and/or location configurations of reagent vessels. Mat 126 is one of several interchangeable pads configured (e.g. by size and by specific indentations 126a) to complement respective proprietary autosampler racks or carousels of a range of proprietary analysis instruments of different types and different suppliers.

Mats 125, 126 and mats 121-4 and/or racks 32 have identifier elements 130 such as barcodes or RFiD tags at their rear edge faces (when laid on support base 21) for a purpose to be further explained. It is emphasised that the order of arrangement of the mats, and therefore of the racks and reagent vessels, on support base 21 may vary.

Tool hanging rail 22 mounts a tool support 25 for receiving and positioning a plurality of sample handling tools (only one shown in situ) at known respective positions 26 defined by vertically aligned upper recesses 27 and lower slots 28. Typical such tools would be positive displacement liquid handling tools such as syringes, for example reusable or single use syringes of various calibrated volumes. Others may include a gripper, a stirrer, a vial spinner and a filtration syringe; one actually illustrated in situ is a mirror 100 e.g. to facilitate reading of identifier elements 130. The positive displacement liquid handling tools (e.g. syringes) include needles able to sealingly penetrate closures, e.g. septa, on sample receptacles and reagent vessels, for accessing and aspirating controlled volumes of sample or reagent, or for delivering contents of the syringe to a sample receptacle. It will be understood that tool support 25 may be at any other suitable location, e.g. at one or other side, or split between two locations.

Tool support 25 in effect hangs off the front of rail 22: it includes a rearward overhang plate 24 that is fastened atop the rail and from which variously shaped elements 29 project or are suspended to provide recesses 27 and slots 28.

A tool engagement and drive device 50 is mounted atop rail 20 for translation in three dimensional space by a mechanism comprising an XYZ drive system 60. Drive system 60 includes a primary cantilevered arm 62 that is traversable above and along rail 20 on a pair of guide rods 64, between endstops provided by mounting blocks 65 for rods 64. The drive unit for this X axis movement is a motor 66 that rotates a threaded rod 68: rod 68 is journalled centrally in mounting blocks 65 and threadingly engages a matching boss on arm 62. Motor 66 is fixed atop the left end rail 20 by an angle bracket 67.

In a similar fashion, spaced guide rods 74 positioned by mounting blocks 75 on arm 62 and a motor 76 with a threaded rod 78 journalled in blocks 75 guide and drive an upright carriage 72 in the Y direction along arm 62. Carriage 72 is a vertically extending channel with a rearwardly projecting gusseted platform 73 that receives and slides along guide rods 74. In turn, a slide block 82 on which device 50 is mounted—travels vertically, i.e. the Z direction, along carriage 72 via guide rods 84 employing a motor 86 and a threaded rod 88. Again, mounting blocks 85 position rods 84 and journal threaded rod 88.

Tool engagement and drive device 50 comprises a U-shaped housing 51 that is open to the rear and is fixed to slide block 82 by an angle bracket 58a. Housing 51 has a releasable coupling head 53 suspended from the upper arm of housing 51 for embracing and automatically releasably engaging a complementary head 53a of each of the tools on tool support 25. In FIG. 1, one such tool—a syringe 140—is shown coupled to head 53. The lower arm of housing 51 has a slot 54 at its forward edge to receive the syringe barrel 142 and suspends a needle guide 55 for guiding and reinforcing the needle 144 of syringe 140 at a position 57 below the syringe barrel. The syringe plunger (not visible) is selectively driven by a small motor 56 via a threaded rod 58. Motor 56 is supported atop a post 59 upstanding from housing 51.

Suitable forms of coupling configuration 53, 53a include the XCHANGE® coupling mechanism and those disclosed in the aforementioned International patent publication WO 2009/046482.

Device 50 includes an identification reader such as a barcode or RFiD reader or readers for reading identifier elements on sample receptacles/vials, and the earlier-mentioned identifier elements 130 on the rear edge faces of mats 121-126 or racks 32.

To the left of the main frame 11 is an operator interface in the form of a touch screen 90 which is adjustably projected towards the operator by being mounted on a cantilevered articulated arm 92 fitted to the side of left hand corner post 13. This cantilevered arm 92 includes articulation joints both adjacent the post and at an intermediate axis 93. Touch screen 90 is the operator interface for a main PC control unit comprising a separate motherboard and flash drive disposed behind wall panel 150: cable 152 is shown to represent the connection of this control unit to the apparatus as a whole.

The settings of the various components of the apparatus, the individual tasks to be performed by device 50 and sample preparation operations embodying one or more of those tasks are displayed and operator selected via a graphical user interface (GUI) 110 on screen 90 that is designed for ease of understanding and for operation of the apparatus with minimum acquired skill. FIG. 3 is a snapshot of the graphical user interface after certain selections have been made, for the purpose of illustrating its layout and mode of use.

The main component of the GUI 110 is a rectangular matrix 112 of user actuable control elements or buttons 114 arranged in columns 116 and rows 118. The rows represent numbered task sequences. The columns 116 are as follows from left to right, in each case giving the heading of the column and then its function:
1. “Input rack”: the identity of a rack of first sample receptacles located at first station 30. In a typical laboratory, this is likely to be an internal characterisation system, exemplified here by the button “Input Group A”.
2. “Reagent”: a specified reagent vessel positioned at reagent station 35.
3. “Tool”: a specified sample handling tool positioned at tool support 25.
4. “Task”: one of a range of pre-programmed selectable sample preparation tasks that are performed on sample liquid extracted from one or more of the first sample receptacles, utilise one or more of the sample handling tools and deliver the prepared sample to a second sample receptacle at second station 40.
5. “Output rack”: the identity of a rack of second sample receptacles located at station 40. This will typically be, as earlier discussed, a dedicated proprietary rack for a specific analyser instrument.

The buttons 114 have associated operator-activated pop-up menus from which the operator must select, for example, the appropriate reagent, the required tools and the respective sample preparation tasks. Once the tasks and the sample preparation are selected, activation of a RUN button 115 cause the control unit to activate device 50 and drive system 60 to carry out a sample preparation operation selected from a plurality of pre-programmed sample preparation operations, which selected operation. includes picking up one or more of the tools, extracting sample liquid from one or more of the first sample receptacles of racks 32 and reagent from one or more of reagent vessels 36, and delivering the prepared sample to a respective second sample receptacle of a rack on mat 126. The main control unit is pre-programmed to know the layout of vials on an identified sample receptacle rack, to extract a sample from each vial of a rack at station 30, to carry out a selected task and deliver the prepared sample to the vials of a rack at station 40. The correspondence between vials at input and output is either known or an audit trail is created by employing barcodes on the vials and presenting the bar code reader to the vials.

In the example illustrated in FIG. 3, the samples have been loaded in vials in an input group A. Sample preparation task #1 is for device 50 to collect tool 2 (a 25 μl syringe) from tool support 25, move above the next vial on the rack, drive i.e. displace the syringe needle to sealingly penetrate the vial closure or septum and then aspirate an aliquot sample before withdrawing the needle from the vial closure or septum. Task #2 is then to move the syringe containing the sample over reagent bottle 1 containing a known standard, and drive i.e. displace the needle to sealingly penetrate the septum and aspirate a controlled volume of the standard, before the syringe is withdrawn and moved to station 40 (holding a Shimadzu NS carousel rack) to deliver the prepared sample to a vial of the output rack. Typically, this delivery task is again effected by driving, i.e. displacing, the needle to sealingly penetrate the vial closure or septum. Task #3 is separated on the GUI from tasks 1 and 2: it involves diluting all vials on the Shimadzu rack with diluent extracted from reagent vessel 1 employing tool 5.

Device 50 includes a spring component in the syringe drive that detects the presence of a reactive force at the needle tip and thereby acts as a sensor as to whether there is a vial or vessel septum in the downward trajectory of the needle: if not, the attempted penetration is terminated and the device moved to a new vial location.

It will be seen that the preferred concept of this invention involves taking samples from vials or tubes in input sample racks, preparing the samples in turn based on predefined sample preparation tasks, and dispensing the prepared sample into an autosampler vial in an instrument specific autosampler carousel/rack. The autosampler carousel/rack is then manually transferred to the instrument specific autosampler, which facilitates the automated analysis of the prepared samples.

This approach to automation of laboratory sample preparation has a number of significant advantages. Increased sample throughput is accompanied by increased productivity. The risks of human error are removed by machine controlled repeatability. The system is highly flexible in terms of required analysis and will render the laboratory better able to handle multiple analyses. There is a significant cost reduction through reduced labour requirements and fewer reworked samples, reduced instances of repetitive strain injury (RSI) cases, and lower laboratory staff turnover.

The facility to handle output racks of different configurations, i.e. a range of instrument specific autosampler racks or carousels, renders the apparatus able to prepare racked samples for a variety of such instruments without any need to manually transfer vials to other racks, or samples to other vials. The corresponding facility at the input side allows the instrument to accept samples in the original collection vials, thus eliminating labour intensive preparation (e.g. liquid transfers or sample partitioning) upstream of the inventive instrument. To facilitate these flexible strategies, rather than processing sample vials through the instrument by performing preparation operations on the samples in the vials, the preferred apparatus adapts a workflow concept in which the sample is extracted from an input vial, subjected to one or more selectable preparation operations, and then delivered to an output vial. It is mentioned, however, that alternative workflow concepts, e.g. the movement of vials from input to output, or the performance of an operation on a sample and then return of the sample to a vial at the same station (i.e. input vial to input vial or output vial to output vial) may be employed when appropriate or preferred. Finally, it is noted that the apparatus is further flexible in being able to handle sample vials of differing volumes: it is not restricted to a prescribed vial size such a standard 2 ml vial.

Importantly, by providing tool engagement and drive device that effects extraction and delivery by displacing the needles to sealingly penetrate closures on the first and second sample receptacles and reagent vessels, the use of open sample containers, or the temporary opening of closed sample containers, can be avoided, thus reducing the risk of environmental contamination of samples.

It will be understood that the invention disclosed and defined in this specification extends to all alternative combinations of two or more of the individual features mentioned or evident from the text or drawings. All of these different combinations constitute various alternative aspects of the invention.

1-30. (canceled)

31. Apparatus for preparation of samples for analysis comprising:
structure for interchangeably locating first racks of sample receptacles that contain samples to be prepared for analysis and second racks of sample receptacles, which second racks include racks of different configuration that are respectively transferable to different analysis instruments, and for receiving and positioning a plurality of reagent vessels at known respective positions; and
an assembly of devices actuable to transfer samples from sample receptacles of the first rack to sample receptacles of the second rack, while carrying out a sample preparation operation selected from a plurality of pre-programmed sample preparation operations;
wherein the apparatus is configured to identify which of said second racks of different configuration is located at said structure, and to adapt said transfer and said selected sample preparation operation to suit the identified rack.

32. Apparatus according to claim 31, wherein the structure includes a support base and interchangeable mounting mats to complement the second racks of different configurations; optionally wherein the apparatus is configured to identify which of the second racks is located at the structure by identifying the presence of one of the mounting mats and for identifying the particular mat and thereby the complementary rack.

33. Apparatus according to claim 31 further including a support base, accessible from the front for interchanging racks and/or reagent vessels located on the structure; optionally wherein the reagent vessels are disposed between the first rack(s) sample receptacles and the second rack(s) of sample receptacles.

34. Apparatus according to claim 31 wherein the apparatus is configured to identify which of the second racks is located at the structure by means of an identification reader on or adjacent said structure.

35. Apparatus according to claim 31, where the assembly of devices includes a tool support for receiving and positioning a plurality of sample handling tools at known respective positions, and a tool engagement and drive device carried by a mechanism for translating the device in three dimensional space, wherein the device and mechanism are actuable to carry out a sample preparation operation selected from a plurality of pre-programmed sample preparation operations, which selected operation includes picking up one or more of said tools, extracting sample liquid from one or more of said sample receptacles at the first racks and reagent from one or more of said reagent vessels, and delivering the prepared sample to one or more respective said sample receptacles at the second rack; optionally wherein the tool engagement and drive device is actuable to effect said extraction and delivery by displacing the needles to sealingly penetrate, and thereafter withdraw from, closures on the sample receptacles of the first and second racks and on the reagent vessels.

36. Apparatus according to claim 35 wherein the tool engagement and drive device includes a head for releasably and selectively engaging the sample handling tools; optionally wherein the sample handling tools comprise one or more of (i) positive displacement liquid handling tools such as syringes, reusable syringes of varying volumes and single use syringes of varying volumes, (ii) a stirrer, (iii) a gripper, (iv) a vial spinner and (v) a filtration syringe; optionally wherein said apparatus includes said sample handing tools.

37. Apparatus according to claim 31, wherein for when the first racks include racks of different configuration the apparatus is configured to identify which of said first racks of different configuration is located at said structure, and to adapt said transfer and said sample preparation operation to suit the identified rack, whereby said apparatus is adaptable to process samples presented in first racks of varied configuration.

38. Apparatus for preparation of samples for analysis, comprising:
structure for interchangeably locating racks of first sample receptacles that contain samples to be prepared for analysis and racks of second sample receptacles that are transferrable to analysis instruments, and for receiving and positioning a plurality of reagent vessels at known respective positions;
a tool support for receiving and positioning a plurality of sample handling tools at known respective positions which sample handling tools include positive displacement liquid handling tools, having needles able to sealingly penetrate closures on sample receptacles and reagent vessels; and
a tool engagement and drive device carried by a mechanism for translating the device in three dimensional space, wherein the device and mechanism are actuable to carry out a sample preparation operation selected from a plurality of pre-programmed sample preparation operations, which selected operation includes picking up one or more of said tools, extracting sample liquid from one or more of said first sample receptacles and optionally reagent from one or more of said reagent vessels, and delivering the prepared sample to one or more respective said second sample receptacles; and
wherein the tool engagement and drive device is actuable to effect said extraction and delivery by displacing the needles to sealingly penetrate, and thereafter withdraw from, closures on the first and second sample receptacles and reagent vessels.

39. Apparatus according to claim 38 further including a support base, accessible from the front for interchanging racks and/or reagent vessels; optionally wherein the reagent vessels are disposed between the first sample receptacles and the second sample receptacles.

40. Apparatus according to claim 38 wherein the tool support comprises a plurality of tool mounts arranged along the rear of and above the support base, and the translation mechanism with its tool engagement and drive device are arranged so that the latter moves about and above the base for accessing sample receptacles, reagent vessels, and sample handling tools at the tool support.

41. Apparatus according to claim 38 wherein said structure further includes a support base and interchangeable mounting mats configured to complement respective racks of varying dimensions and/or vial location configurations.

42. Apparatus according to claim 41 further including means for identifying the presence of one of said mounting mats and for identifying the particular mat and thereby the rack; optionally wherein said identifying means is an identification reader.

43. Apparatus according to claim 38 wherein the tool engagement and drive device includes a head for releasably and selectively engaging the sample handling tools; optionally wherein the sample handling tools comprise one or more of (i) positive displacement liquid handling tools such as syringes, reusable syringes of varying volumes and single use syringes of varying volumes, (ii) a stirrer, (iii) a gripper, (iv) a vial spinner and (v) a filtration syringe.

44. Apparatus according to claim 38, wherein for when the first racks include racks of different configuration the apparatus is configured to identify which of said first racks of different configuration is located at said structure, and to adapt said transfer and said sample preparation operation to suit the identified rack, whereby said apparatus is adaptable to process samples presented in first racks of varied configuration.

45. Apparatus according to claim 38 wherein said apparatus includes said sample handing tools; optionally wherein the positive displacement liquid handling tools comprise syringes.

46. A method of preparing samples for analysis comprising:
delivering a rack of first sample receptacles that contain samples to be prepared for analysis;
locating racks of second sample receptacles that are transferrable to analysis instruments;
providing a plurality of reagent vessels at known respective positions;
providing at a tool support a plurality of sample handling tools at known respective positions which sample handling tools include positive displacement liquid handling tools having needles able to sealingly penetrate closures on sample receptacles and reagent vessels; and
actuating a tool engagement and drive device and a mechanism for translating the device in three dimensional space to carry out a sequence of sample preparation operations selected from a plurality of pre-programmed sample preparation operations, which selected operations each include picking up one or more of said tools, extracting sample liquid from one or more of said first sample receptacles and reagent from one or more of said reagent vessels, and delivering the prepared sample to a respective said second sample receptacle;
wherein the tool engagement and drive device effects said extraction and delivery by displacing the needles to sealingly penetrate, and thereafter withdraw from, closures on the first and second sample receptacles and reagent vessels.

47. Apparatus for preparation of samples for analysis comprising:
structure for interchangeably locating first racks of sample receptacles that contain samples to be prepared for analysis and second racks of sample receptacles, which first racks include racks of different configuration, and for receiving and positioning a plurality of reagent vessels at known respective positions; and
an assembly of devices actuable to transfer samples from sample receptacles of the first rack to sample receptacles of the second rack, while carrying out a sample preparation operation selected from a plurality of pre-programmed sample preparation operations;
wherein the apparatus is configured to identify which of said first racks of different configuration is located at said structure, and to adapt said transfer and said selected sample preparation operation to suit the identified rack, whereby said apparatus is adaptable to process samples presented in first racks of varied configuration, that may include sample receptacles of varied types and/or sizes.

48. Apparatus according to claim 47, where the assembly of devices includes a tool support for receiving and positioning a plurality of sample handling tools at known respective positions, and a tool engagement and drive device carried by a mechanism for translating the device in three dimensional space, wherein the device and mechanism are actuable to carry out a sample preparation operation selected from a plurality of pre-programmed sample preparation operations, which selected operation includes picking up one or more Of said tools, extracting sample liquid from one or more of said sample receptacles at the first racks and reagent from one or more of said reagent vessels, and delivering the prepared sample to one or more respective said sample receptacles at the second rack.

49. Apparatus according to claim 48 wherein the tool engagement and drive device includes a head for releasably and selectively engaging the sample handling tools; optionally wherein the sample handling tools comprise one or more of (i) positive displacement liquid handling tools such as syringes, reusable syringes of varying volumes and single use syringes of varying volumes, (ii) a stirrer, (iii) a gripper, (iv) a vial spinner and (v) a filtration syringe.

50. Apparatus according to claim 47, wherein for when the first racks include racks of different configuration the apparatus is configured to identify which of said first racks of different configuration is located at said structure, and to adapt said transfer and said sample preparation operation to suit the identified rack, whereby said apparatus is adaptable to process samples presented in first racks of varied configuration.
